(19) United States
(12) Patent Application Publication
(10) Pub. No.: US 2025/0353030 A1
(43) Pub. Date: Nov. 20, 2025

(54) METHOD AND APPARATUS FOR APPLYING A TREATMENT SUBSTANCE ON A RUNNING PAPER WEB OR BOARD WEB

(71) Applicant: Andritz Küsters GmbH, Krefeld (DE)

(72) Inventors: Eduard Davydenko, Grefrath (DE); Andreas Pesch, Krefeld (DE)

(21) Appl. No.: 19/203,360

(22) Filed: May 9, 2025

(30) Foreign Application Priority Data
May 14, 2024 (DE) 10 2024 113 445.3
May 2, 2025 (EP) 25173990.0

(51) Int. Cl. B05C 1/08

(52) U.S. Cl. CPC B05C 1/0826

(57) ABSTRACT

Method and apparatus for applying a treatment substance to a running paper or board web comprising an applicator with at least one free-jet nozzle having an outlet gap for applying the treatment substance, being a machine-width, film-like jet, to a moving substrate, in particular at least one applicator roll which transfers the treatment substance to the paper or board web in a treatment nip defined by the at least one applicator roll with a counter element, wherein the free-jet nozzle is positioned at an angle to the moving substrate in such a way that an angle φ to the perpendicular of an impingement line of the coating on the moving substrate is between 5° and 85°, and the intensity of the jet impulse at the impingement line is increased by a gravitational acceleration of the jet caused by an adjustable effective height H from the outlet gap of the free-jet nozzle, and a jet curvature along a path length is modulated via the angle φ.

The invention relates to a method and an apparatus for applying a treatment substance or medium to a running paper or paperboard web using a free jet applicator that applies the treatment substance to a moving substrate. In the case of direct application, the substrate can be the surface of a paper, board or other fibrous web and, in the case of indirect application, the surface of a transfer element, in particular an applicator roll, which transfers the treatment substance to the surface of the fibrous web. The applicator roll forms a treatment nip with a counter element. The treatment substance is applied without contact to the moving substrate by means of a free jet nozzle to apply a treatment substance.

Recovered paper fibers are increasingly being used in the production of packaging paper and paperboard as well as special papers. In the EU, for example, testliner is mainly made from recovered paper and fillers. Due to the high proportion of secondary fibers, the strength properties of packaging papers are reduced. The use of starch in paper production can compensate for the loss of strength. The starch is usually either added directly to the pulp suspension or sprayed onto the wet web in the wire section. Furthermore, the starch can be applied to the paper web immediately after the pre-drying group using contact or non-contact application methods.

Film presses known from DE 4131131 A1, for example, provide contact application methods. The starch or sizing agent suspension is applied to an applicator roll with the aid of a metering applicator and metered by means of a blade. The paper or paperboard web is coated on both sides in a press nip between the applicator rolls. The temperature of the starch is usually between 50 and 80° C. The typical solids content of the starch is between 8 and 15% with a coating weight of 0.2 to 6 g/m² per side. In some cases, a film press of this type can also be used to apply coating color comprising starch and pigment particles with a solids content of up to 40% to the paper or paperboard web. The line forces between the applicator rolls are usually between 40 and 70 kN/m.

Non-contact methods for applying starch, for example pond size presses, are known from DE 34 17 487 A1 or from the publication Gullichsen, J., Paulapuro, H.: Papermaking Science and Technology, Book 11, Pigment Coating and Surface Sizing, Helsinki, 2000, p. 49, Paulapuro, H.: Papermaking Science and Technology, Book 11, Pigment Coating and Surface Sizing of Paper, Helsinki, 2000, p. 491. From EP 2 811 069 A1 and DE 20 2013 102 761 U1 spray application methods are known for applying a surface sizing mixture to the surface of a fiber web, which passes through a nip for pressing the surface sizing mixture onto the web. In these processes, the metering element for the application quantity is a quantity control at the application nozzles. No blade devices for coaters are required.

The film presses with spray nozzles have the decisive disadvantage that the maximum solids content of the starch is limited to approx. 14%. Especially when the starch has a high solids content, starch particles adhere to the nozzles. This leads to streaking and the resulting uneven distribution of the starch across the width of the web. In the worst case, this can lead to blockages in the nozzles and interruptions in production.

Curtain sizing is another non-contact process for applying starch. Curtain sizers are known, for example, from WO 2020/020626 A1, DE 10 2019 122 371 A1, EP 3 617 403 A1, AT 519598 A2, EP 3 875 684 A1 and EP 4 283 039 A1. In this method, the starch is applied directly to rotating applicator rolls. A curtain coater is used for this purpose. In a curtain applicator, the nozzle is arranged in the upper position of the roll. After exiting the nozzle, a free-falling starch curtain is formed, which is constantly accelerated by the effect of gravity. The drop height of the curtain between the gap opening and the impingement zone on the applicator roll is usually 50-250 mm. The velocity of the curtain in the impingement point of the impingement zone is therefore considerably higher than the exit velocity of the starch coming out of the nozzle.

Critical for the runnability of the curtain coating nozzles is the splashing of the starch curtain when the starch hits the roll surface. If the impingement speed of the curtain is too high, the curtain can be reflected. This effect occurs in particular at low viscosities and high volume flow rates. The moving surface of the applicator roll has a negative influence on the stability of the curtain. The rotating roll creates a boundary layer air that acts in the point of impingement of the curtain. This effect becomes stronger at higher roll speeds. To prevent skip coating by pushing air through the curtain, the air influences must be reduced. A blade is used as an air repellent to eliminate irregular air. Another option is to remove the irregular air from the impingement zone using a suction device.

The free jet applicator with a jet nozzle was developed in the early 1990s for coating paper with a coating color. In the free jet applicator, the nozzle is located underneath the backing roll. The distance between the nozzle lip and the applicator roll is usually between 5 and 20 mm. This is described in Gullichsen, J., Paulapuro, H.: Papermaking Science and Technology, Book 11, Pigment Coating and Surface Sizing of Paper, Helsinki, 2000, p. 437. A free jet of coating color is generated with a nozzle and the paper is coated directly. The jet is directed from bottom to top and is usually aligned at an angle to the tangent of the roll contact surface. This angle is in the range of 25-45°. Several factors are decisive for the choice of jet impingement angle. Firstly, depending on the velocity difference between the jet and the paper web, the mass flow and the viscosity of the color, the angle is adjusted so that there is no backflow of the color in the impingement zone (return flow). On the other hand, care must be taken to ensure that the interfering air is removed from the coating zone, thus preventing skip coating. Furthermore, the jet should not be splashed from the roller surface (jet reflection).

However, a free jet applicator can also be used to apply starch to the applicator roll, as known from WO 2020/020626 A1. The nozzle is arranged in a position underneath the roll or on the side of the roll.

The impingement angle must be optimally chosen. If the angle is too steep, there is a risk of the starch splashing back. There is also a very high risk of heel formation. If the angle is too flat, the impulse force of the jet is not sufficient to displace interfering air from the impingement zone. Air between the jet and the roll surface impedes the wetting of the roll.

This causes the starch film to detach from the roll again due to the effect of centrifugal forces. Coating paper is therefore no longer possible.

A disadvantage of a free jet applicator with a jet nozzle, however, is that the impulse force of the jet is not sufficient to push away the boundary layer air from the impingement zone at a low volume flow. This is the case with application weights of less than 2 g/m².

FI 103354 B describes a jet coater that is equipped with a guide plate. This guide plate is provided to protect the nozzle lip from damages caused by web breaks and to guard the applying area against the boundary layer air. The distance between the guide plate and the roll surface is selected so that it is smaller than the distance between the nozzle tip and the roll surface. The guide plate is attached to the upper lip of the nozzle. The guide plate always has a distance to the roll surface, as otherwise the paper web would be damaged. The sealing against air is therefore not complete.

Due to these restrictions, free jet applicators are limited to a maximum speed of 800-900 m/min when using starch. At higher speeds, the jet impulse is not large enough to remove boundary layer air at the impingement line. Packaging papers in particular, such as testliner (TL) and corrugated medium (CM), are usually produced at high speeds. The production speed of TL and CM is at least 800 m/min. The standard speed is between 1000 and 1500 m/min. Speeds of up to 1800 m/min are achieved on modern paper machines for CM and TL.

In order to save evaporation energy, attempts tend to be made to increase the solids content. The solids content of the starch can be increased from 10-13% to 14-18%. When the solids content is increased, the specific volume flow of the starch in the jet decreases. This reduces the jet velocity in a free jet applicator. This reduces the impulse force of the jet and thus the ability to displace interfering air from the impingement zone. This reduces the maximum speed that can be achieved and is in contrast to the ever-increasing machine speeds required. However, this could be partially compensated for with a smaller nozzle gap. The impulse force and the particle size are decisive for the adjustment of the outlet gap. On the one hand, the gap is set as small as possible so that the jet impulse is large enough to displace the interfering air from the impingement zone. On the other hand, however, care must be taken to ensure that the gap is not too small so that starch particles and fines do not stick to the outlet gap.

DE 100 12 344 A1 discloses a curtain coating method for applying liquid or pasty treatment medium in the form of a curtain to a moving substrate. The exit velocity of the treatment medium from the dispensing nozzle is between about 0.02 m/s and about 6.30 m/s. The exact course of the treatment medium curtain from the dispensing nozzle to the substrate deviates somewhat from a strictly vertical course due to various effects.

One effect to be mentioned is the so-called “teapot effect”, which is based on the fact that the nozzle lips of the dispensing nozzle usually extend differently in the dispensing direction of the curtain. Adhesive forces between the treatment medium to be applied and the longer nozzle lip result in deformation of the medium curtain. This deformation can be counteracted by tilting the dispensing nozzle about an essentially horizontal axis. The tilt angle can have a value of between approximately 5° and 20°. In order to also prevent the entry of air between the material web and the medium layer, the point of impact of the curtain is arranged downstream of the apex of the circumferential surface of the roll in relation to the direction of travel of the substrate. Speeds of the material web can range between approximately 500 m/min and 3000 m/min.

Overall, however, it can be seen that the negative influence of the boundary layer air increases at higher speeds, which has not yet been effectively combated.

It is an object of the present invention to provide an improved method and a compactly constructed apparatus for applying treatment substance with which the influence of the boundary layer air is strongly reduced.

The object is achieved by the features of claim 1 and claim 15.

Herewith a method and an apparatus are provided that increase the resulting impulse force of the treatment medium applied in the form of a jet, by an impingement on the moving substrate using a gravitationally induced jet curvature. A technologically and economically efficient process for applying starch with a higher solids content (to increase the strength properties of the paper or board) at high speeds and low specific volume flows can be achieved.

It is the merit of the inventors to have recognized that the influence of the boundary layer air can be greatly diminished by a new applying method and a new applying apparatus, providing a significantly increased jet impulse. The increased jet pulse is used to remove the boundary layer air at the impact line even at higher speeds. The nozzle is arranged in such a way that the gravitational force supports the jet impulse.

For this purpose, the nozzle is preferably arranged in a position above the roll, at a greater distance from the roll than would normally be the case with a free jet applicator (coater). The jet then has the shape of a parabola, it is longer and can be 30-150 mm. Gravitational forces are now added to the impulse of the jet when coming out of the nozzle. This increases the total impulse of the jet depending on the effective height, determined by the vertical height difference between the selected reference horizontal line drawn through the outlet gap of the free jet nozzle and the impingement line on the moving substrate (influence of the gravitational force).

The impulse of the jet in the impingement position is also influenced by determining the position of the jet at the exit point of the nozzle upstream of the impingement position of the curtain in relation to the travel direction of the substrate. In addition to the initial height, the jet deflection to the vertical can also be adjusted to influence the jet impulse in the impingement position by a selectable horizontal position shift of the nozzle in relation to the impingement position. This applies in particular if the impingement position is to be held in a fixed position relative to the doctor blade for an air barrier for different operating conditions, for example different running speeds of the substrate.

An angled arrangement of the nozzle in conjunction with the effective height provides a parabolic jet, which is a typical feature of the type of coating according to the invention. According to the invention, the free jet applicator, in contrast to a curtain applicator, also has the decisive advantage that, due to the angular alignment of the jet, the resulting impulse force acts in the moving direction of the roll upon impact. This prevents the starch from splashing back.

Further advantages and embodiments of the invention can be learned from the following description and the dependent claims.

The invention is explained in more detail below using the exemplary embodiments shown in the appended figures.

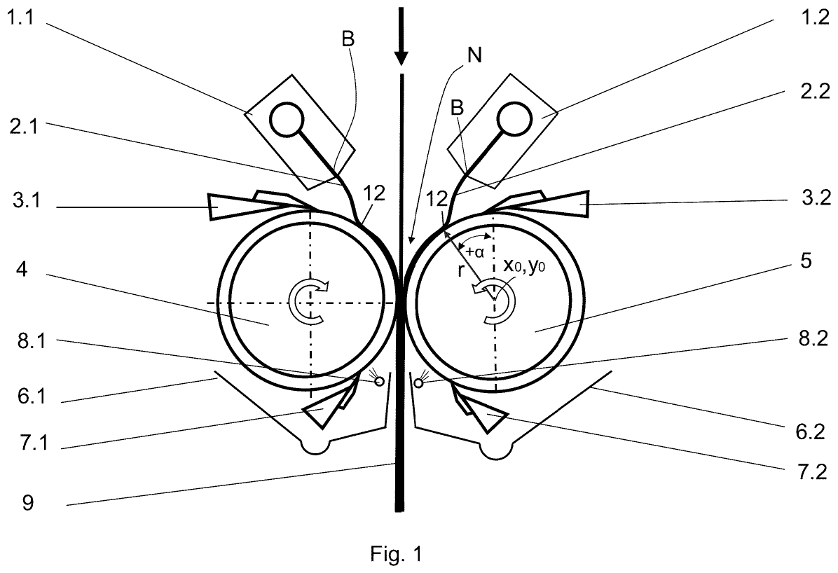

FIG. 1 schematically shows a cross-section of a device according to the invention for applying treatment substance or medium using a free-jet nozzle according to a first exemplary embodiment,

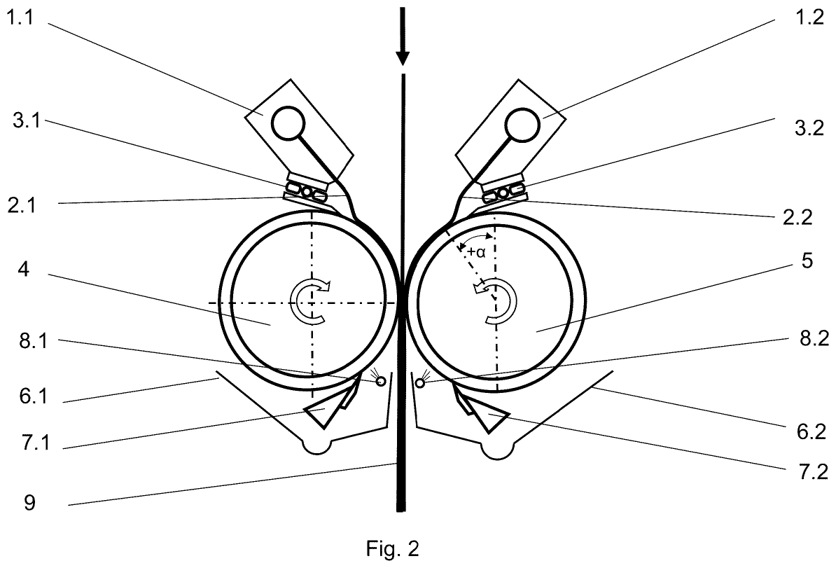

FIG. 2 schematically shows a cross-section of a device according to the invention for applying treatment substance or medium using a free-jet nozzle according to a second exemplary embodiment,

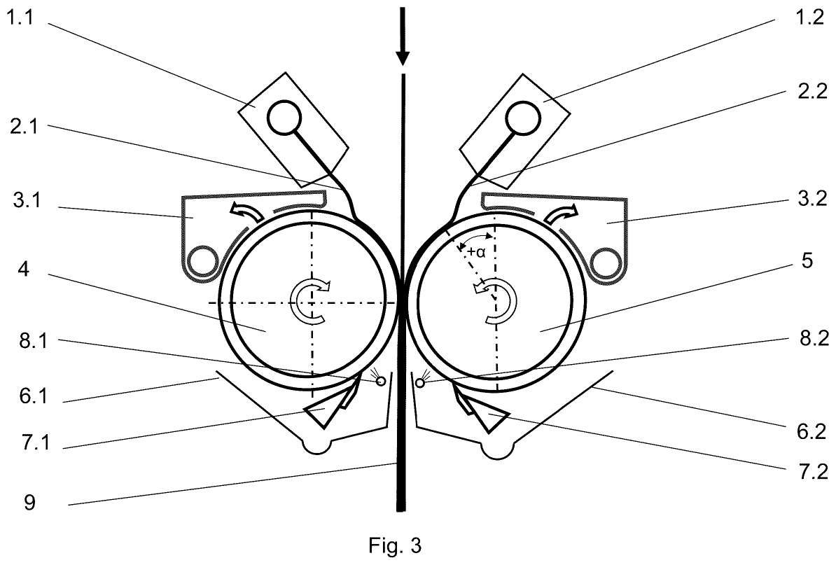

FIG. 3 schematically shows a cross-section of a device according to the invention for applying treatment substance or medium using a free-jet nozzle according to a third exemplary embodiment,

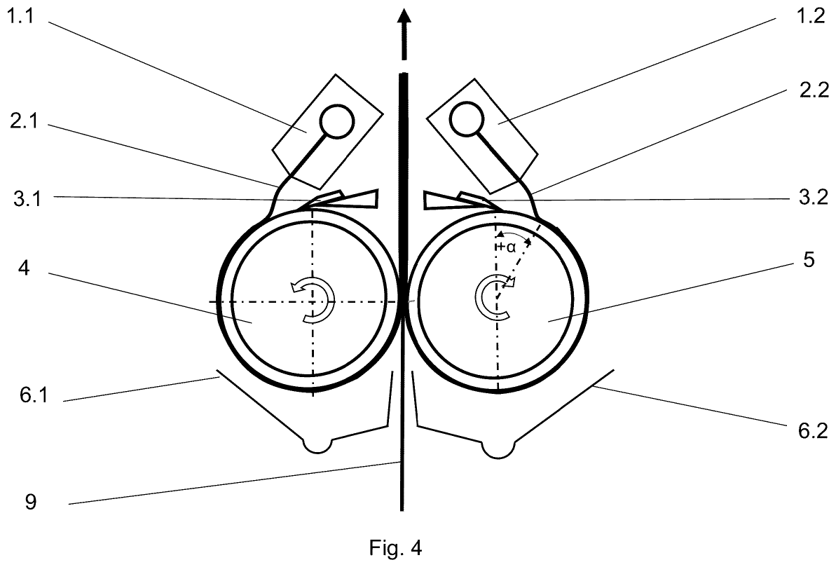

FIG. 4 schematically shows a cross-section of a device according to the invention for applying treatment substance or medium by using a free-jet nozzle according to a fourth exemplary embodiment,

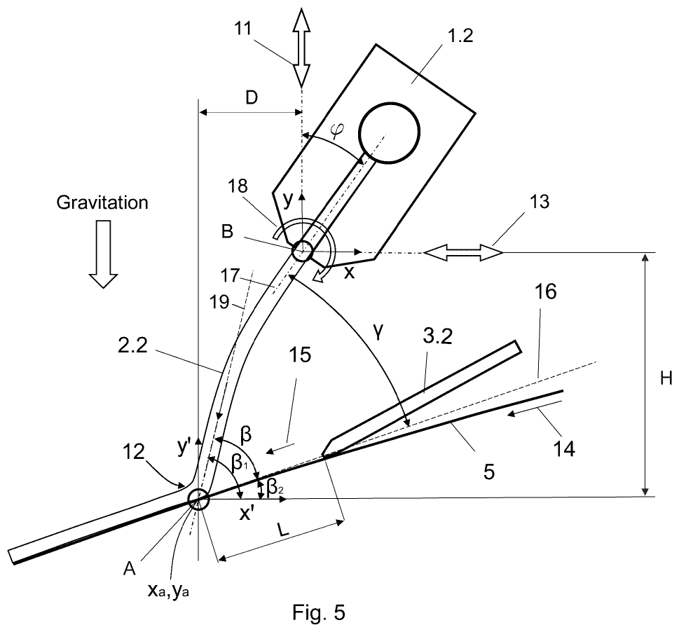

FIG. 5 schematically shows a section of FIG. 1 with a positioning system for locational and angular shifting of a free-jet nozzle relative to a substrate in a gravity-oriented reference system,

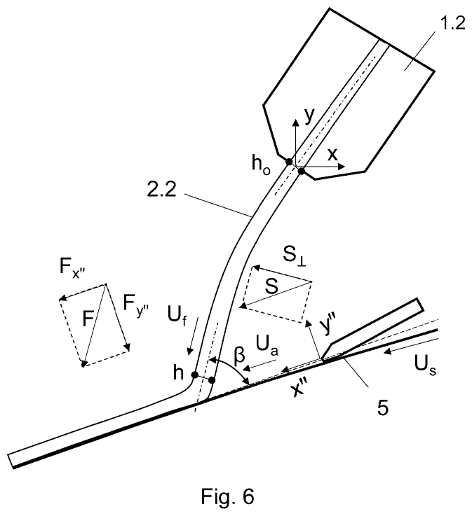

FIG. 6 schematically shows the physical processes in the impingement zone of the parabolic jet on the moving substrate with the impulse force of the boundary layer air (air-pressure S) and the impulse force of the jet perpendicular to the substrate (stabilizing impulse force Fy″),

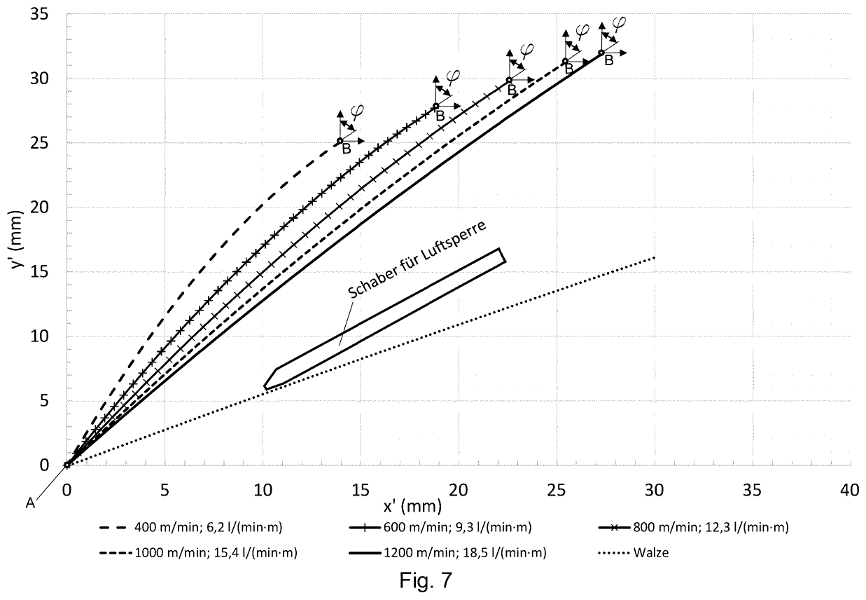

FIG. 7 shows jet contours for different operating points depending on the speed (m/min) of the substrate and the specific volume flow (l/min×m) of a treatment medium,

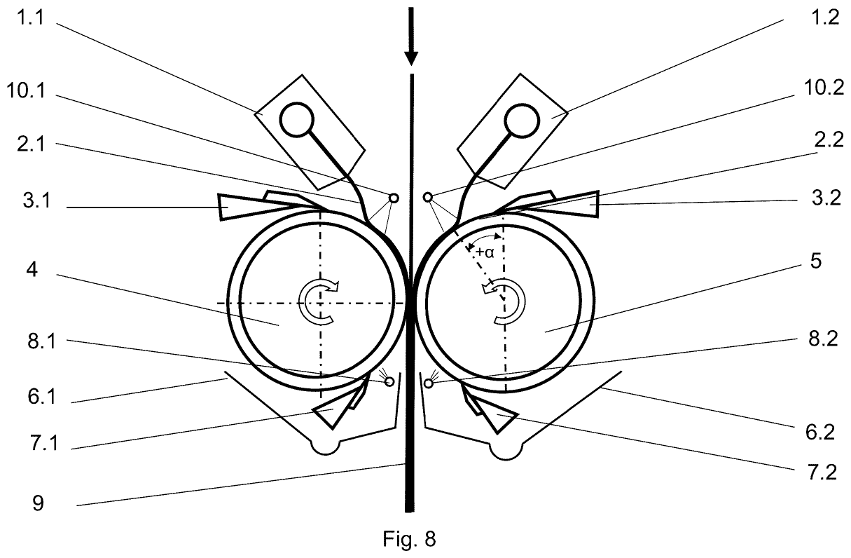

FIG. 8 schematically shows a cross-section of a device according to the invention for applying treatment medium by means of a free-jet nozzle according to a fifth exemplary embodiment comprising an additional blow nozzle.

As FIG. 1 shows, the invention relates to a method for applying a treatment substance or medium to a running paper or board web 9 by means of an applicator with at least one free jet nozzle 1.1, 1.2 having an outlet gap B for applying the treatment medium in the form of a machine-width, film-like jet 2.1, 2.2 to a moving substrate. The moving substrate here is preferably at least one applicator roll 4, 5. The treatment medium is transferred to the paper or board web 9, in particular to the surface of the paper and board web 9, in a treatment nip N, which is formed by the at least one applicator roll 4, 5 with a counter element, which is preferably also an applicator roll 4, 5.

Here, for example, the treatment medium is first applied to both sides of the rotating applicator rolls 4, 5 using two nozzles 1.1, 1.2. Each of the nozzles 1.1, 1.2 is positioned relative to the respective applicator roller 4, 5 such that an angle a for the impingement position 12 of the coating on the applicator roller 4, 5 is between 0° and 90°, preferably between 15° and 45° to the vertical. The angle a is specified relative to the center of rotation of the respective applicator roll 5.

Furthermore, an air barrier scraper 3.1, 3.2, i.e. a device for combating the boundary layer air carried along by the substrate, is preferably assigned to the coating unit. Without this control device, the stability of the jet 2.1, 2.2 and the coating quality would be impaired due to the influence of the boundary layer air, as already explained above. Such an air barrier scraper 3.1, 3.2 is preferably assigned to each of the nozzles 1.1, 1.2, in order to at least minimize the boundary layer air introduced with the fast-running respective applicator roll 4, 5. The air barrier scrapers 3.1, 3.2 can be in contact with the roll 4, 5 (and thus with the roll surface) under pressure in order to work particularly effectively. Non-contact operation of the scrapers 3.1, 3.2 to prevent wear reduces the effectiveness of the boundary layer air removers, but may be provided, in particular in conjunction with other devices for combating the boundary layer air entrained by the substrate. A boundary layer air extraction system can also be provided as a supplement or alternative, as described below.

To reduce the boundary layer air, that can reach the applicator unit and negatively affect the applying result, the respective air barrier scraper 3.1, 3.2 is preferably at a distance of 1 to 100 mm, particularly preferably 10 to 30 mm, from the free jet nozzle 1.1, 1.2, i.e. in the direction of rotation upstream of the substrate, in this case the applicator roller 4, 5. This distance is adjustable and is defined according to the invention as the distance L from the scraper 3.1, 3.2 to the impact position 12 of the jet 2.1, 2.2 on the application roller 4, 5 (see FIG. 5). In FIG. 5, the direction of the disturbing air flow is indicated by the arrow 15 and the machine direction of the moving substrate, in this case the applicator roll 5, is indicated by the arrow 14.

As FIG. 1 shows in combination with FIG. 5, the method according to the invention provides that the respective free-jet nozzle 1.2 is positioned at an angle to the moving substrate, in this case the applicator roll 5, such that an angle φ to the perpendicular of an impingement line A of the coating on the moving substrate is between 5° and 85°, preferably 30° and 70°, and the intensity of the jet impulse at the impingement line A is increased by a gravitational acceleration of the jet 2.2 is increased by an adjustable effective height or distance H from the outlet gap B of the free jet nozzle 1.2, whereby the utilization of a jet curvature of the respective jet 2.2 can be modulated over a path length via the angle φ.

The distance length is preferably the geometric distance between the measuring points outlet gap B and impingement line A of the impingement position 12. The effective height H is preferably a vertical height difference between reference horizontal lines, one of which intersects the outlet gap B or the mouth of the free jet nozzle 1.2 and the other the impingement line A on the surface of the substrate. The effective height H is then the distance H, as shown in FIG. 5

For setting a selectable jet curvature on a path length of the medium jet 2.2, a device can be provided as a positioning system for positional/locational displacements 11, 13 and angular adjustments 18 of the free-jet nozzle 1.2 for height adjustment by means of distance H and longitudinal adjustment by means of distance D of the free-jet nozzle 1.2 in the direction of travel 14, in particular the direction of rotation of the roll, relative to the substrate, in particular the applicator roll 5, which is designed in a gravity-oriented reference system, as described below.

The functional principle on which the method according to the invention is based is further explained with reference to FIG. 5 as follows. The nozzle 1.2 is preferably positioned in the upper position relative to the applicator roll 5. The jet 2.2 is directed from top to bottom. As a result, an additional component of the jet impulse is generated by the effect of gravity. The effect of gravity is indicated by the arrow labeled gravity. The angle φ to the vertical, which defines the impact position 12 of the coating on the application roller, is approx. 30° to 46° in this example (according to FIG. 5).

The height, specified as distance H, is a distance that can be adapted from the outlet gap B of the nozzle 1.2 to the applicator roll 5 to the specific volume flow of a treatment medium. A higher position of the nozzle 1.2 generates a larger jet impulse. This is used to remove the boundary layer air at the impingement line A even at higher speeds.

The ratio of a jet impingement angle β to a jet exit angle γ can have an amount β/γ=1 to 6, preferably 1 to 3. The jet impingement angle β lies between the tangent 16 to the applicator roller 5 at the impingement line A and the tangent 19 of the jet 2.2 at the intersection of the impingement line A. The jet exit angle γ lies between the tangent 16 to the applicator roll 5 at the impingement line A and the center line 17 of the jet 2.2 in the outlet gap B of the nozzle 1.2.

In embodiment shown in FIG. 5, the jet exit angle γ is 35°, for example, and the jet impingement angle β is 58°, for example, so that the ratio β/γ=1.7. Due to the angular orientation of the jet 2.2, caused by the modulation of the angle φ, the resulting impulse force acts in the direction of travel of the roll on impact. In addition to increasing the impulse force, this can prevent the treatment medium, in particular the starch, from splashing back.

The jet outlet angle γ can be adjusted via the angular position φ of nozzle 1.2. The angle of nozzle 1.2 can be adjusted manually or by motor. The jet impingement angle β can be determined using a camera and digital image processing, for example. This data can then be used to automatically adjust the jet exit angle γ.

The ratio of the height adjustment/length adjustment distances (H/D) characterizes the difference between a jet applicator with free jet nozzle and a curtain applicator. While the ratio is very large in the curtain applicator and normally approaches ∞—as the point at which the curtain hits the roll is vertically below the exit point from the nozzle—, it is relatively small in the jet applicator and is preferably below 3.

Typical values for common operating points and commercially available starches are between 1 and 2.

Consequently, the method according to the invention can be designed in such a way that a jet curvature is determined over a path length by a jet exit angle γ between an exiting jet 2.1, 2.2 at the exit gap B of the free jet nozzle 1.1, 1.2 and the tangent 16 on the at least one application roller 4, 5 to the impingement line A and a jet impingement angle β between the tangent 19 of a jet 2.1, 2.2 impinging on the applicator roll 4, 5 and the tangent 16 on the applicator roll 4, 5 at the impingement line A.

The ratio of the jet impingement angle β to the jet exit angle γ from the nozzle 1.1, 1.2 can be selected in the range between β/γ=1 and 6, preferably between β/γ=1 and 3, in order to adapt the intensity of the jet impulse at the impingement line A to specific volume flows of the treatment medium. The jet impingement angle β can be set as a function of the web speed, viscosity/solids content, volume flow of the treatment medium. The jet impingement angle β can be selected in the range between 10° and 90°, preferably between 10° and 60°, and particularly preferably between 20° and 40°. The jet exit angle γ from the nozzle 1.1, 1.2 can be selected in the range between 10° and 90°, preferably between 10° and 45°, and particularly preferably between 15° and 35°. The angle a can be selected in the range between 0° and 90°, preferably between 15° and 45°.

The application medium can be starch, a sizing agent or a coating color.

The distance H from the outlet gap B of the nozzle 1.1, 1.2 to the substrate, in particular to the applicator roll 4, 5, and the jet outlet angle γ can be selected in such a way that the effective height H is between 10 mm and 300 mm, preferably between 10 mm and 150 mm, and particularly preferably between 25 mm and 100 mm.

A device 3.1, 3.2 for boundary layer air removal can be arranged upstream of the impingement line A of the jet 2.1, 2.2 on the substrate, in particular the applicator roll 4, 5, with a distance L of 1 to 100 mm, preferably 10 to 30 mm. The paper or board web speed can be between 250 m/min and 2000 m/min, preferably between 600 m/min and 1800 m/min. The outlet gap B of the nozzle 1.1, 1.2 can be 100-500 μm. The weight of the treatment medium can be in the range between 0.2-15 g/m² per side of the paper or cardboard web. Starch with a solids content of between 6% and 35%, preferably between 15% and 35%, and particularly preferably between 10% and 25%, and a viscosity of between 20 mPa*s and 200 mPa*s can be selected as the treatment medium.

The temperatures of the starch can be between 50° C. and 110° C., preferably between 60° C. and 100° C. The temperature of a treatment medium, in particular a coating color or pigment color, can be 25-45° C. The paper or board web can be coated in an upward or downward direction.

In the case of direct applying, the running substrate can be the surface of a paper, paperboard or other fibrous web and, in the case of indirect applying, the surface of a transfer element that transfers the treatment medium to the surface of the fibrous web in a treatment nip. The above remarks on indirect application by means of an applicator roll 4, 5 thus apply in the same way to direct application of treatment medium to the fibrous web. The applying of treatment medium can be carried out on one or both sides.

The device according to the invention for applying at least one liquid or pasty treatment medium by means of a free-jet applicator to a moving substrate is designed such that the substrate is the surface of a paper, paperboard or other fibrous web in the case of direct application and the surface of a transfer element, in particular an applicator roll 4, 5, in the case of indirect application, which transfers the application medium to the surface of the fibrous web, in particular in a treatment nip N. The free jet applicator has at least one free jet nozzle 1.1, 1.2 with an outlet gap B for emitting a medium jet 2.1, 2.2, which applies the medium jet 2.1, 2.2 to the surface of the substrate like a film and achieves a desired width (in the transverse direction of the machine) of an application layer at an impingement position 12. A device for adjusting the intensity of the jet impulse of the medium jet in the impingement position 12 is arranged, wherein the device is designed as a positioning system for locational and angular shifts 11, 13, 18 of the free jet nozzle 1.1, 1.2 relative to the substrate, wherein a reference direction for describing the instantaneous spatial and angular position of the free jet nozzle 1.1, 1.2 relative to the impingement position 12 is given by the gravitational field.

In order to set a selectable jet curvature on a section length of the medium jet 2.1, 2.2, the positioning system for positional and angular shifts or displacements of the free jet nozzle can be designed for a vertical and/or longitudinal adjustment of the free jet nozzle 1.1, 1.2 in direction 14 of the machine running direction relative to the substrate in a gravity-oriented reference system.

The gravity-oriented reference system can be designed with systems of spatial Cartesian coordinates X, Y, Z, of which one origin for the angular displacement φ can be located in a mouth of the outlet gap B of the free jet nozzle 1.1, 1.2 and another origin for the positional displacement in the impingement position 12 and the impingement line A on the surface of the substrate. The respective X-axis can be directed in such a way that a right-hand system or left-hand system is provided and the perpendicular line is determined by the gravity field-related local perpendicular direction. The free-jet nozzle 1.1, 1.2 can be positioned at an angle φ to the local perpendicular direction in relation to the gravity field, preferably in the range from 30° to 70°. Due to the positioning of the free jet nozzle 1.1. 1.2, the impulse force of the jet 2.1, 2.2 in the impingement position 12 can be selected to be greater, depending on the coating parameters, than an impulse force on the rear side of the jet surface due to a dynamic pressure caused by a boundary layer air on the moving substrate.

FIG. 7 shows operating windows for different paper or board web speeds in conjunction with different volume flows for the positioning of the free jet nozzle 1.1, 1.2 according to FIG. 1 in conjunction with FIG. 5 with regard to the positioning of the outlet gap B in the system x′, y′ in order to adjust the jet curvature of the jet 2.1, 2.2 in relation to the impingement line A.

FIG. 1 shows spray water or water vapor nozzles 8.1, 8.2 and scrapers 7.1, 7.2 with associated collecting tray 6.1, 6.2 preferably provided for cleaning the applicator rolls 4, 5.

FIG. 2 shows a second embodiment of the invention. In contrast to FIG. 1, the air barrier scraper 3.1, 3.2 is attached directly to the nozzle 1.1, 1.2. The embodiment shown here is, for example, with a DST scraper for lifting the scraper blade on and off. A uniform and sensitively adjustable contact pressure is advantageous here. However, other versions of the scraper are also conceivable.

FIG. 3 shows a third embodiment of the invention. In contrast to FIG. 1, a boundary layer air removal device 3.1, 3.2 is provided here instead of the air barrier scraper. This can be, for example, a boundary layer air suction device or a so-called air scraper.

FIG. 4 shows a further embodiment of the invention. In contrast to FIG. 1, the direction of paper travel is opposite here.

The physical processes in the impingement position 12 of the jet 2.1, 2.2 on the roll 4, 5 are explained in more detail with reference to FIG. 6 in combination with FIG. 5 and FIG. 1.

The movement of the substrate, in particular the roll 4, 5, creates a boundary layer air that runs into the jet 2.1, 2.2 from behind and causes a dynamic pressure there. The dynamic pressure can also be seen as the impulse force of the boundary layer air. This impulse force disrupts the coating process. The component S_{⊥} of this impulse force presses on the back of the jet surface. This can cause the jet to lift off the roll 4, 5 so that the starch film detaches from the roller 4, 5 again. The air then penetrates between the roll surface and the treatment film and hinders the wetting of the roll 4, 5.

A stabilizing force acts against this, being the impulse force of the jet 2.1, 2.2. The component F_{y″} of this force presses the jet 2.1, 2.2 onto the roll 4, 5 at the point of impact of the impingement line A and acts against the lifting of the starch film from the roll surface. The impulse force F_{y″} acts perpendicular to the roll surface.

The jet impulse F and the component F_{y″} can be calculated using the following equations, which are known from the publication Guyon, E., Hulin, J. P. and Petit, L.: Hydrodynamik, 1997, Braunschweig/Wiesbaden, p. 188:

$$F = {ρ}_{f} {{U}_{f}}^{2} h \qquad ( 1 )$$

$${F}_{{y}^{″}} = F sin β \qquad ( 2 )$$

F_{x″} Component of the impulse force F of jet 2.2 in x″ direction (FIG. 6), N

F_{y″} Component of the impulse force F of the jet 2.2 perpendicular to the surface of the applicator roll 5 (FIG. 6), N

ρ_{f} Density of the treatment medium, kg/m³

U_{f} Velocity of the jet 2.2 of the treatment medium in the impingement point of the impingement line A, m/s

h jet thickness at the point of impingement of the impingement line A on the applicator roll 5, μm

The jet thickness h (FIG. 6) at the point of impact of the impingement line A can be calculated from the law of conservation of mass and is the same:

$$h = \frac{{U}_{fo}}{{U}_{f}} {h}_{o} \qquad ( 3 )$$

hₒ Jet thickness at the exit point from nozzle 1.2 (at the outlet gap), μm

U_{fo} Velocity of the jet at the exit point from the nozzle 1.2, m/s

The jet velocity U_{f} at the point of impact:

$${U}_{f} = \sqrt{{U}_{fx}^{2} + {U}_{fy}^{2}} \qquad ( 4 )$$

U_{fx} and U_{fy} are the components of the jet velocity in the x and y directions at the point of impact.

The component U_{fx} of the jet velocity in the x-direction:

$${U}_{fx} = {U}_{fo} cos ( 90 ° - φ ) = {U}_{fo} sin φ \qquad ( 5 )$$

φ Angle for the position of nozzle 1.2 according to FIG. 5

The component U_{fy} of the jet velocity in the y-direction at the point of impact:

$${U}_{fy} = \sqrt{{U}_{fo}^{2} {sin}^{2} ( 90 ° - φ ) + 2 {gy}_{a}} = \sqrt{{U}_{fo}^{2} {cos}^{2} φ + 2 {gy}_{a}} \qquad ( 6 )$$

The coordinates xₐ and yₐ of the point of impact of the jet 2.2 on the applicator roller 5 as shown in FIG. 5 are determined by solving equations (7) and (8):

Equation for the contour of the roll surface:

$$y = \sqrt{{r}^{2} - {( x - {x}_{o} )}^{2}} + {y}_{o} \qquad ( 7 )$$

Equation for the jet contour or for the trajectory parabola:

$$y = x tan ( 90 ° - φ ) - \frac{{x}^{2} g}{2 {U}_{fo}^{2} {cos}^{2} ( 90 ° - φ )} = x cot φ - \frac{{x}^{2} g}{2 {U}_{fo}^{2} {sin}^{2} φ} \qquad ( 8 )$$

In equations (7) and (8), the coordinates of the point of impact of the jet 2.2 on the applicator roll x=xₐ and y=yₐ must be entered.

The absolute values for xₐ and yₐ correspond to the effective height H and the horizontal distance D as shown in FIG. 5:

$$\vert {x}_{a} \vert = D$$

$$\vert {y}_{a} \vert = H$$

xₒ and yₒ Coordinates of the roller center point according to FIG. 1

r Radius of the applicator roller 4, 5.

The jet impingement angle β can be determined using the equations for the tangents 16, 19 for the contour of the roll surface and for the jet contour, which are derived from the differentiation of equations (7) and (8) according to x.

Equation for the tangent 19 of the jet contour:

$$y = ( tan ( 90 ° - φ ) - \frac{{x}_{a} g}{{U}_{fo}^{2} {cos}^{2} ( 90 ° - φ )} ) \cdot ( x - {x}_{a} ) + {y}_{a} = ( cot φ - \frac{{x}_{a} g}{{U}_{fo}^{2} {sin}^{2} φ} ) \cdot ( x - {x}_{a} ) + {y}_{a} \qquad ( 9 )$$

Equation for the tangent 16 to the roll surface:

$$y = - \frac{{x}_{a} - {x}_{o}}{\sqrt{{r}^{2} - {( {x}_{a} - {x}_{o} )}^{2}}} \cdot ( x - {x}_{a} ) + {y}_{a} \qquad ( 10 )$$

Angle β₁ between the jet tangent 19 and the x-axis at the point of impact of the impingement line A:

$$tan {β}_{1} = tan ( 90 ° - φ ) - \frac{{x}_{a} g}{{U}_{fo}^{2} {cos}^{2} ( 90 ° - φ )} = cot φ - \frac{{x}_{a} g}{{U}_{fo}^{2} {sin}^{2} φ} \qquad ( 11 )$$

Angle β₂ between the tangent 16 to the roll surface and the x-axis at the point of impact:

$$tan {β}_{2} = - \frac{{x}_{a} - {x}_{o}}{\sqrt{{r}^{2} - {( {x}_{a} - {x}_{o} )}^{2}}} \qquad ( 12 )$$

If the angles β₁ and β₂ are known, the jet impingement angle β can be calculated:

$$β = {β}_{1} - {β}_{2} \qquad ( 13 )$$

The following formula can be used to calculate the component of the impulse force of the disturbing (troublesome) air flow S_{⊥}:

$${S}_{⊥} = {ρ}_{a} q {U}_{a} \frac{1 + cos β}{sin β} \qquad ( 14 )$$

S_{⊥} Component of the momentum force of the disturbing air flow perpendicular to the jet 2.2, N

ρₐ Density of air, kg/m³

q specific volume flow of the disturbing air flow, m³/(m*s)

Uₐ Average velocity of the disturbing air flow, m/s

This equation is known from the publication Eklund, D. E.: Influence of blade geometry and blade pressure on the appearance of coated surface. Tappi Journal, May (1984), pp. 66-70, equation (1).

The specific volume flow of the air in the boundary layer can be calculated according to Sakiadis, as described below.

Source: Sakiadis, B. .: Part II. The Boundary Layer on a Continuous Flat Surface. AlChE Journal, Vol. 7 (1961), no. 2, p. 221-225

Thickness of the boundary layer air δ (m):

$$δ = \sqrt{\frac{4}{0.183}} \sqrt{\frac{v {x}^{′′}}{{U}_{s}}} \qquad ( 15 )$$

Us Speed of the applicator roll, m/s

v kinematic viscosity of air, m²/s

The specific volume flow of the disturbing air flow q results from the integration of the velocity distribution u (y″) over the thickness of the air boundary layer y″ and can be calculated using equation (16):

$$\frac{q}{{U}_{s}} = δ - {δ}^{2} + \frac{1}{2} {δ}^{4} - \frac{1}{5} {δ}^{5} \qquad ( 16 )$$

x″ and y″ are the coordinates shown in FIG. 6.

At the point of impact of jet 2.2 on roll 5, x″=L.

The mean velocity of the disturbing air flow Uₐ can be calculated by integrating equation (25) in the publication Sakiadis, B.C. (1961):

$$\frac{{U}_{a}}{{U}_{s}} = {\int }_{0}^{1} erfc ( \frac{η}{2} ) d η \qquad ( 17 )$$

The greater the jet velocity, the greater the stabilizing component F_{y″} of the impulse force of the jet 2.2. As the velocity of the roll 5 increases, the velocity of the disturbing air flow increases and thus also the disturbing component S_{⊥}.

To ensure that the interfering air is displaced from the coating zone, the force F_{y″} should be greater than S_{⊥}. On the other hand, the ratio F_{y″}/S_{⊥} must not be too high so that the jet does not bounce off the roll surface. For a good coating, the ratio F_{y″}/S_{⊥} must be within an optimum range. This range must be redetermined for each system configuration, as adhesion forces are also effective in addition to the jet impulse, which can assume different values depending on the roll coating or the type of thickness, for example. For this purpose, reference points must be determined for the lower and upper limits of the current configuration. If these are known, the valid ratio of F_{y″}/S_{⊥} can be derived. The formulas then make it possible to predict the areas in which the system must be operated.

The meaning of the ratio F_{y″}/S_{⊥} is explained in Table 1. The typical coating parameters for the production of CM are given here as an example. In setting no. 1, CM is produced with 160 g/m² at a speed of 800 m/min. Starch of 3.5 g/m² per side with a typical solids content of 12.5% is applied. The distance H is 33.8 mm, for example. The distance D is 30 mm, for example. With these settings, the ratio F_{y″}/S_{⊥} is greater than 1, i.e. the force F_{y″} is greater than S_{⊥}. The starch film remains stable in the point of impact of the impingement on the roll. The jet velocity at the outlet of the nozzle is 1.4 m/s and increases to 1.65 m/s at the point of impact.

When changing to CM with 130 g/m², the weight of the treatment substance is reduced to 3 g/m² and the speed is increased to 1100 m/min (settings no. 2, table 1). The distance H, for example, is 34.9 mm. The increase in speed leads to a deterioration of the ratio F_{y″}/S_{⊥} by approx. 36% to 0.7, i.e. the disturbing component S_{⊥} has become greater than F_{y″}. The impulse force F_{y″} is no longer sufficient to counteract the disruptive effect of the boundary air flow. The starch jet lifts off the roll. The wetting of the roll is disturbed. Coating of the paper is no longer possible.

To stabilize the coating process, the nozzle is positioned higher. The distance H to the roll increases accordingly (setting no. 3), for example 99 mm. With these settings, the ratio F_{y″}/S_{⊥} increases to 1.6 and is significantly greater than 1, i.e. the disruptive component S_{⊥} is significantly smaller than F_{y″}. With these settings, the impulse force F_{y″} is sufficient to compensate for the disruptive effect of the boundary air flow. The starch jet no longer lifts off the roll. Wetting of the roll is restored. Coating the paper is possible again with this setting.

At low roll speeds, the effect of the boundary layer air becomes weaker and the ratio F_{y″}/S_{⊥} becomes >1 (setting 4) even at low jet speeds at the nozzle outlet.

TABLE 1

| Settings | No. | 1 | 2 | 3 | 4 |
|---|---|---|---|---|---|
| Paper grade | — | CM | CM | CM | CM |
| Basis weight | g/m² | 160 | 130 | 130 | 170 |
| Roll speed | m/min | 800 | 1100 | 1100 | 600 |
| Treatment substance | g/m² | 3.5 | 3.0 | 3.0 | 3 |
| weight per side | | | | | |
| Solids content | % | 12.5 | 12.5 | 12.5 | 12.5 |
| Specific volume flow | I/(min | 21.6 | 25.4 | 25.4 | 13.9 |
| rate, q | m) | | | | |
| Jet velocity coming | m/s | 1.4 | 1.7 | 1.7 | 0.9 |
| out of the nozzle | | | | | |
| Jet thickness in the | μm | 218 | 225 | 193 | 192 |
| impingement point, h | | | | | |
| Angle γ | ° | 15.7 | 15.5 | 17.7 | 16.1 |
| Angle β | ° | 22.3 | 20.7 | 29.2 | 28 |
| Angle ratio β/γ | — | 1.4 | 1.3 | 1.65 | 1.73 |
| Distance L | mm | 22 | 22 | 22 | 22 |
| Distance D | mm | 30 | 31.7 | 78.6 | 24.1 |
| Distance H | mm | 33.8 | 34.9 | 99 | 30.6 |
| Ratio H/D | — | 1.13 | 1.1 | 1.26 | 1.27 |
| Angle position of the | ° | 45.2 | 45.2 | 45.2 | 45.2 |
| nozzle, φ | | | | | |
| Jet velocity in the | m/s | 1.65 | 1.9 | 2.2 | 1.2 |
| impingement point | | | | | |
| Force ratio F_{y}/S_{⊥} | — | 1.1 | 0.7 | 1.6 | 1.1 |

FIG. 7 shows different distances H of the outlet gap B of a free jet nozzle 1.2 (see FIG. 5 and FIG. 6). Preferably, two boundary conditions determine the gap width hₒ of the outlet gap B. A first boundary condition is determined by the impulse ratio at the point of impact of the impingement line A, which should preferably be greater than 1. The smaller the nozzle gap, the greater the jet impulse. It therefore makes sense to make the nozzle gap as small as possible. However, this increases the probability of the nozzle gap becoming blocked by particles in the application medium. The filtering of the treatment medium is subject to technological and economic restrictions. For this reason, gap widths hₒ of less than 100 μm are difficult to achieve. In the example shown in FIG. 7, for example a gap width of 250 μm was calculated. The positioning of the position/location of the nozzle 1.2 by means of position shifts, shown by double arrows 11 (distance H), 13 (distance D), and angle settings φ of the free jet nozzle 1.2 with the outlet gap B (cf. FIG. 5) results from the above formulae.

Numerical data of the graphical representation of FIG. 7 are summarized in Table 2 below.

TABLE 2

| | | No. | | | | |
|---|---|---|---|---|---|---|
| Settings | | 5 | 6 | 7 | 8 | 9 |
| Paper grade | — | CM | CM | CM | CM | CM |
| Basis weight | g/m² | 175 | 170 | 130 | 120 | 115 |
| Roll speed | m/min | 400 | 600 | 800 | 1000 | 1200 |
| Treatment substance | g/m² | 2 | 2 | 2 | 2 | 2 |
| weight per side | | | | | | |
| Solids content | % | 12.5 | 12.5 | 12.5 | 12.5 | 12.5 |
| Specific volume flow | l/(min | 6.2 | 9.3 | 12.3 | 15.4 | 18.5 |
| rate, q | m) | | | | | |
| Jet velocity coming | m/s | 0.4 | 0.6 | 0.8 | 1.0 | 1.2 |
| out of the nozzle | | | | | | |
| Jet thickness in the | μm | 129 | 164 | 188 | 199 | 211 |
| impingement point, h | | | | | | |
| Angle γ | ° | 10.8 | 10.6 | 10.4 | 26.4 | 26.3 |
| Angle β | ° | 41 | 37.4 | 33.4 | 36.9 | 34.4 |
| Angle ratio β/γ | — | 4.0 | 3.5 | 3.2 | 1.4 | 1.3 |
| Distance L | Mm | 20 | 20 | 20 | 20 | 20 |
| Distance D | Mm | 11.4 | 14.8 | 17.2 | 25.4 | 27.3 |
| Distance H | Mm | 23.7 | 25.5 | 26.8 | 31.2 | 31.8 |
| Ratio H/D | — | 2.0 | 1.7 | 1.6 | 1.2 | 1.17 |
| Angle position of the | ° | 38.9 | 38.9 | 38.9 | 45.2 | 45.2 |
| nozzle, φ | | | | | | |
| Jet velocity in the | m/s | 0.8 | 0.9 | 1.1 | 1.3 | 1.5 |
| impingement point | | | | | | |
| Force ratio F_{y}/S_{⊥} | — | 1.4 | 1.0 | 0.9 | 1.1 | 1.0 |

In order to stabilize the coating process, the jet stability in the impingement zone can be improved by additional measures. A method for stabilizing the coating process with air blow nozzles is known from patent specifications DE 10 2020 117 953 A1 and EP 1 266 093 A1. A blow nozzle 10.1, 10.2 (FIG. 8) or a series of blow nozzles can be arranged in the upper position between the nozzle and the treatment nip. The blowing air is directed at the point of impact/impingement of the jet perpendicular to the roll 4, 5 or at a slight angle to the roll tangent. A blow nozzle will increase the ratio of F_{y″}/S_{⊥} and thus improve the jet stability.

For this purpose, the coating medium is engaged with air between the treatment nip of the rolls 4, 5 and the transfer to the web. In order to minimize the volume flow of the interfering boundary layer air, the distance L from the air barrier scraper/blade 3.1, 3.2 to the impingement line A of the jet is set to 1 to 100 mm, preferably 10 to 30 mm.

The treatment/coating medium can be starch, coating colors, plastic compounds such as PVA or a mixture of these media. The coating medium is then transferred to the paper or board web in the nip between the applicator rolls. One applicator roll can be a hard (heated) roll, which can be equipped with a ceramic cover. The other applicator roll can be a profiling roll, which is equipped with a hard ceramic cover or a soft polymer cover with a hardness of 15-30 P &J, for example. The applicator rollers are usually tempered.

The new process can be used for starch application (sizing) and pigmentation (pigmenting).

The starch is applied with a solids content of between 6% and 35%, preferably between 15% and 35%, particularly preferably between 10% and 25%, and a viscosity of between 20 mPa*s and 200 mPa*s. The treatment substance weight is in the range between 0.2 g/m² and 6 g/m² per side. A film of thickness in the range of 10 ml/m² to 40 ml/m² is applied to the applicator roll.

1. Method for applying a treatment substance to a running paper or board web comprising an applicator with at least one free-jet nozzle having an outlet gap for applying the treatment substance, being a machine-width, film-like jet, to a moving substrate, in particular at least one applicator roll which transfers the treatment substance to the paper or board web in a treatment nip defined by the at least one applicator roll with a counter element, wherein the free-jet nozzle is positioned at an angle to the moving substrate in such a way that an angle φ to the perpendicular of an impingement line of the coating on the moving substrate is between 5° and 85°, and the intensity of the jet impulse at the impingement line is increased by a gravitational acceleration of the jet caused by an adjustable effective height from the outlet gap of the free-jet nozzle, and a jet curvature along a path length is modulated via the angle φ.

2. Method according to claim 1, wherein a jet curvature is determined on a path length by a jet exit angle γ between an exiting jet at the outlet gap of the free jet nozzle and the tangent at the at least one applicator roll to the impingement line and a jet impingement angle β between the tangent of a jet impinging on the applicator roll and the tangent at the applicator roll at the impingement line.

3. Method according to claim 2, wherein the ratio of the jet impingement angle β to the jet exit angle γ from the nozzle is selected in the range between β/γ=1 and 6, preferably between β/γ=1 and 3, in order to adapt the intensity of the jet impulse at the impingement line to specific volume flows of the treatment medium.

4. Method according to claim 1, wherein the angle β is adjustable as a function of the web speed, viscosity/solids content, volume flow of the treatment medium.

5. Method according to claim 2, wherein the jet impingement angle β is selected in the range between 10° and 90°, preferably between 20° and 60°, most preferably between 10° and 40°.

6. Method according to claim 1, wherein the jet exit angle γ from the nozzle is selected in the range between 10° and 45°, preferably between 15° and 35°.

7. Method according to claim 1, wherein the angle a is selected in the range between 0° and 90°, in particular between 15° and 45°.

8. Method according to claim 1, wherein the treatment medium is starch, a sizing agent or a coating color.

9. Method according to claim 1, wherein the effective height from the outlet gap of the nozzle to the applicator roll and the jet exit angle γ are selected in such a way that the effective height is between 10 mm and 300 mm, preferably between 10 mm and 100 mm.

10. Method according to claim 1, wherein an apparatus for boundary layer air removal is arranged upstream of the line of impingement of the jet on the applicator roll with a distance of 1 to 100 mm, preferably 10 to 30 mm.

11. Method according to claim 1, wherein the angle φ to the perpendicular of an impingement line of the coating on the moving substrate is between 30° and 70° and the ratio of the distances H and D at the outlet gap to the impingement line of the impingement position is H/D<3.

12. Method according to claim 1, wherein the application weight of the treatment medium is in the range between 0.2-15 g/m² per side of the paper or board web.

13. Method according to claim 1, wherein the paper or board web is coated in an upward or downward direction.

14. Method according to claim 1, wherein the effective height is a vertical height difference between reference horizontal lines, one of which intersects the mouth of the outlet gap of the free jet nozzle and the other of which intersects the impingement line on the surface of the substrate.

15. Apparatus for applying at least one liquid or pasty treatment medium by means of a free-jet applicator to a moving substrate, the substrate being, in the case of direct application, the surface of a paper, board or other fibrous web and, in the case of indirect application, the surface of a transfer element, in particular an applicator roll, which transfers the treatment medium to the surface of the fibrous web, in particular in a treatment nip, and the free-jet applicator having at least one free-jet nozzle which has an outlet gap for discharging a medium jet, which has a free-jet nozzle that transfers the medium jet in a film-like manner onto the surface of the substrate and achieves a desired width of an application layer there in an impingement line, wherein an apparatus for adjusting the intensity of the jet impulse of the medium jet is arranged in the line of impingement, the apparatus being designed as a positioning system for positional and angular shiftings of the free-jet nozzle relative to the substrate, a reference direction for describing the instantaneous spatial and angular position of the free-jet nozzle relative to the line of impingement being given by the gravitational field.

16. Apparatus according to claim 15, wherein for setting a selectable jet curvature on a path length of the medium jet, the positioning system for locational and angular displacements or shiftings of the free-jet nozzle performs a vertical and/or longitudinal adjustment of the free-jet nozzle in the direction of machine travel relative to the substrate in a gravity-oriented reference system.

17. Apparatus according to claim 16, wherein the gravity-oriented reference system defines systems of spatial Cartesian coordinates, of which one origin for the angular displacement or shifting lies in a mouth of the outlet gap of the free-jet nozzle and another for the positional displacement or shifting in the impingement position on the surface of the substrate.

18. Apparatus according to claim 17, wherein the respective X-axis is directed in such a way that a right-hand system or left-hand system is defined and the perpendicular direction is determined by the gravity field-related local perpendicular direction.

19. Apparatus according to claim 15, wherein the free-jet nozzle is arranged at an angle φ with respect to the local perpendicular direction related to the gravity field, which is in a range from 5° to 85°, preferably from 30° to 70°.

20. Apparatus according to claim 15, wherein due to the positioning of the free jet nozzle, the impulse force of the jet in the impingement position is selected to be greater, depending on the coating parameters, than an impulse force on the rear side of the jet surface due to a dynamic pressure caused by a boundary layer air on the moving substrate.
